(19) United States
(12) Patent Application Publication
(10) Pub. No.: US 2021/0131594 A1
(43) Pub. Date: May 6, 2021

(54) MAGNETICALLY ATTACHED HOSE COUPLING SYSTEM

(71) Applicant: Scosche Industries, Inc., Oxnard, CA (US)

(72) Inventor: Michael Kulick, Simi Valley, CA (US)

(21) Appl. No.: 17/085,066

(22) Filed: Oct. 30, 2020

Related U.S. Application Data
(60) Provisional application No. 62/929,264, filed on Nov. 1, 2019.

(51) Int. Cl. F16L 37/00

(52) U.S. Cl. CPC F16L 37/004

(57) ABSTRACT

A hose coupling system includes a first hose coupling defining a through passage with first and second open ends, the first hose coupling having a hose fitting at the first open end and a flange at the second open end, the flange having a face defining a plurality of circumferentially spaced recesses. Magnets are disposed respectively within the circumferentially spaced recesses. The hose coupling system further includes a second hose coupling defining a through passage with first and second open ends, the second hose coupling having a hose fitting at the first open end and a body with a face at the second open end, the face defining an annular recess receptive to the flange of the first hose coupling, the body further defining a receptacle for a mount and having a boss protruding outwardly from within the receptacle. A ferromagnetic ring is disposed within the annular recess.

### CROSS-REFERENCE TO RELATED APPLICATIONS

The application relates to and claims the benefit under 35 U.S.C. § 119(e) to U.S. Provisional Patent Application No. 62/929,264 filed Nov. 1, 2019 and entitled “MAGNETICALLY ATTACHED HOSE COUPLING SYSTEM,” the entire contents of which is wholly incorporated by reference herein.

### STATEMENT RE: FEDERALLY SPONSORED RESEARCH/DEVELOPMENT

Not Applicable

### BACKGROUND

### 1. Technical Field

The present disclosure relates generally to hose couplings and, more particularly, to magnetically attached hose couplings for use in vehicles.

### 2. Related Art

Because a driver of a vehicle must pay attention to controlling the vehicle, particularly at high speeds or in off-road conditions, air and hydration fluid delivery systems have been designed, giving special consideration to the ease of coupling and decoupling delivery hoses. For example, U.S. Patent Application Pub. No. 2018/0195654 proposes the use of a magnetic quick connect for coupling a hose to an interface of a helmet such as a motorcycle helmet. Such magnetic quick connects may allow for simple and straightforward connection as well as disconnection, allowing the driver to be quickly removed from the vehicle in the event of a crash. However, in such systems, when the magnetic quick connect becomes disconnected during normal operation of the vehicle, whether intentionally or inadvertently, the hose that is not attached to the driver's helmet dangles in an arbitrary position and moves around with the movement of the vehicle, making the coupling member difficult for the driver to locate while driving. Thus, safe reconnection of the magnetic quick connect while operating the vehicle remains a challenge.

### BRIEF SUMMARY

The present disclosure contemplates various apparatuses for overcoming the above drawbacks accompanying the related art. One embodiment of the present disclosure is a hose coupling system. The hose coupling system may include a first hose coupling defining a through passage with first and second open ends, the first hose coupling having a hose fitting at the first open end and a flange at the second open end, the flange having a face defining a plurality of circumferentially spaced recesses. The hose coupling system may include a plurality of magnets, each disposed within a respective one of the plurality of circumferentially spaced recesses. The hose coupling system may include a second hose coupling defining a through passage with first and second open ends, the second hose coupling having a hose fitting at the first open end and a body with a face at the second open end, the face defining an annular recess receptive to the flange of the first hose coupling, the body further defining a receptacle for a mount and having a boss protruding outwardly from within the receptacle. The hose coupling system may include a ferromagnetic ring disposed within the annular recess.

Another embodiment of the present disclosure is a hose coupling system. The hose coupling system may include a hose coupling defining a through passage with first and second open ends, the hose coupling having a hose fitting at the first open end and a body with a face at the second open end, the face defining an annular recess receptive to a flange of another hose coupling, the body further defining a receptacle for a mount and having a boss protruding outwardly from within the receptacle. The hose coupling system may include a ferromagnetic ring disposed within the annular recess.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a hose coupling system according to an embodiment of the present disclosure;

FIG. 2 is a partially exploded perspective view of the hose coupling system with the connection between hose coupling and mount;

FIG. 3 is an exploded front perspective view of the hose coupling system with the connection between hose couplings;

FIG. 4 is a exploded rear perspective view of the hose coupling system with the connection between hose couplings;

FIG. 5 is a cross-sectional view of the hose coupling system taken along line 5-5 in FIG. 1;

FIG. 6 is a cross-sectional view of the hose coupling system taken along line 6-6 in FIG. 1;

FIG. 7 is an exploded perspective view of the mount; and

FIG. 8 is bottom perspective view of the mount.

### DETAILED DESCRIPTION

The present disclosure encompasses various magnetically attached hose coupling systems. The detailed description set forth below in connection with the appended drawings is intended as a description of several currently contemplated embodiments. It is not intended to represent the only form in which the disclosed subject matter may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

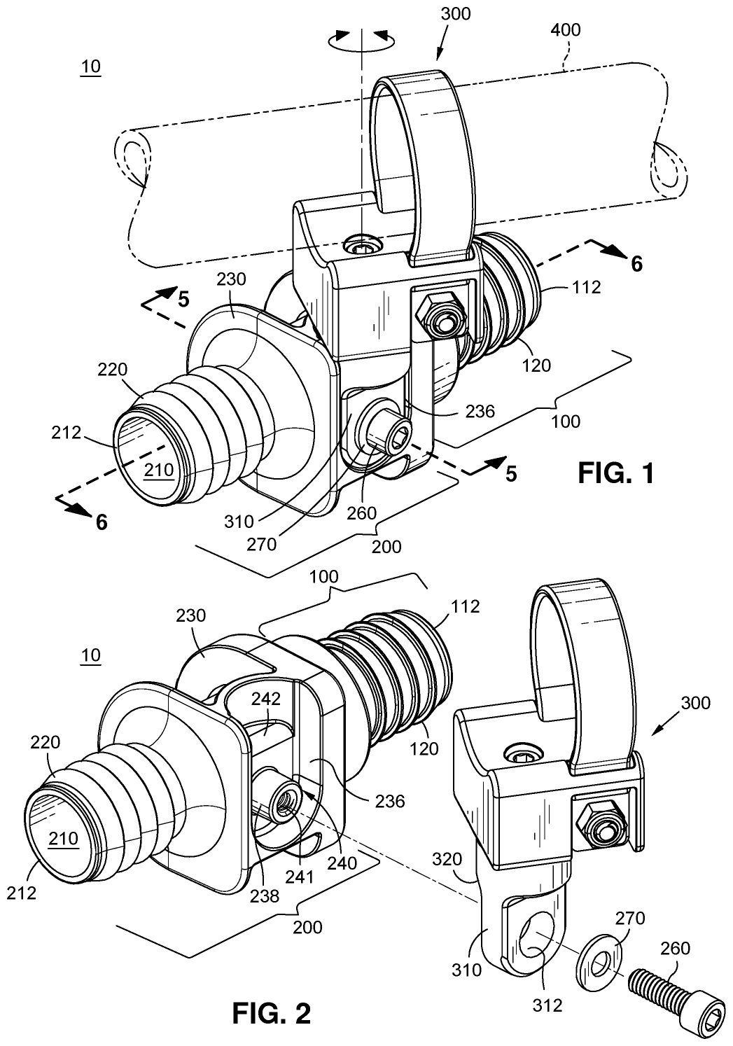

FIG. 1 is a perspective view of a hose coupling system 10 according to an embodiment of the present disclosure. The hose coupling system 10 may include a first hose coupling 100 and a second hose coupling 200 that attach to each other magnetically to fluidly couple two hoses connected to hose fittings 120, 220 thereof. The hose coupling system 10 may further include a mount 300 that connects to the second hose coupling 200. FIG. 2 is a perspective view of the hose coupling system 10 with the connection between the second hose coupling 200 and the mount 300 shown detached relative to each other. It is possible to set up a static connection point that a user, for example, a driver of a vehicle, can conveniently plug into for receiving air, water, or other fluid. The mount 300 may also be secured to the second hose coupling 200 as well as to a vehicle attachment point 400 such as a roll cage, motorcycle handlebar, etc. By virtue of such static connection point, the second hose coupling 200 may thus be positioned at a known, fixed location within the user's reach, where a supply of fluid may be provided from a hose connected to the hose fitting 220. Thus, unlike conventional systems, a driver may magnetically attach the first hose coupling 100 to the second hose coupling 200 with minimal effort and without looking. In this way, a driver wearing a helmet or other article having a hose connected to the hose fitting 120 of the first hose coupling 100 may easily plug into the fluid supply at the static connection point following a disconnection.

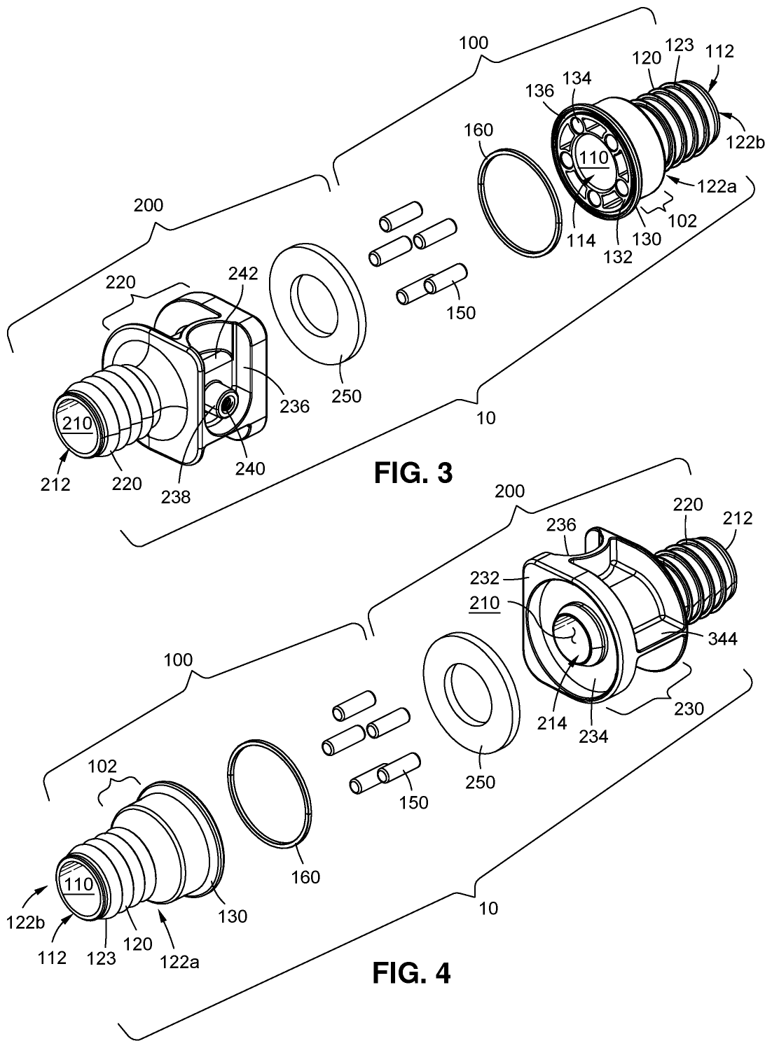

FIG. 3 is a front perspective view of the hose coupling system 10 with the connection between hose couplings 100, 200 show detached from one another. FIG. 4 is a rear perspective view of the same. As shown, the first hose coupling 100 may define a through passage 110 with first and second open ends 112, 114. The hose coupling 100 incorporates the aforementioned hose fitting 120 that is characterized by a proximal fitting end 122a that is contiguous with a coupling body 102, and an opposed distal fitting end 122b that also corresponds to the first open end 112.

In one exemplary embodiment, the coupling body 102 incorporates a series of concentric ribs 123 that may establish a friction fit with the interior of a flexible hose that is slightly undersized but expandable to seal against the circumference of the hose fitting 120. The concentric ribs 123 may each be angled toward the proximal fitting end 122a such that the hose may be inserted onto the hose fitting 120 with relative ease, but restricted when being removed. The types of hose fittings 120, 220 are not intended to be limited to the depicted example. For example, an interior diameter of a flexible hose may be slightly oversized relative to an interior diameter of the hose fitting 120, with a sealed friction fit being established. Other modalities for securing a hose to the hose fitting 120 such as threading, clamps, and so forth may be readily substituted without departing from the scope of the present disclosure. In general, connecting the hose to the first hose coupling 100 is intended to be less convenient and/or more permanent relative to the magnetic connection and disconnection of the corresponding first hose coupling 100 to the second hose coupling 200.

As best shown in FIG. 3, at the second open end 114 of the through passage 110, the coupling body 102 may include a flange portion 130, with the body 102 and the flange portion 130 generally defining a front face 132. In accordance with the illustrated embodiment, the front face 132 may define a plurality of circumferentially spaced recesses 134. In between the circumferentially spaced recesses 134, the coupling body 120 may be partially hollow as shown in order to reduce weight. A plurality of magnets 150 may be disposed within the coupling body 102 of the first hose coupling 100, each within a respective one of the circumferentially spaced recesses 134. The circumferentially spaced recesses 134, and thus the magnets 150, may be evenly spaced around the through passage 110. In the example shown in FIG. 3, there are five such recesses 134 and five corresponding magnets 150. However, numbers greater or less than five are also contemplated. For example, eight recesses 134 and eight corresponding magnets 150 may be used. While it is preferable to provide at least three magnets 150 in order to evenly distribute the magnetic force about the face 132 of the flange 130, two magnets 150 may be suitable in some circumstances, especially in the case of elongated arc-shaped magnets that may be disposed opposite each other around the through passage 110 while still distributing the magnetic force evenly about the face 132 of the flange 130. A single annular magnet in a single annular recess is also contemplated. However, by using at least three magnets 150, preferably at least five magnets 150 as shown, the magnetic force may be evenly distributed while still using ordinarily shaped magnets such as bar magnets or the cylindrical magnets of the illustrated example. The magnets 150 may be permanent magnets such as magnetized ferromagnetic or ferrimagnetic materials that may include iron, nickel, cobalt, ceramic materials such as ferrites, etc.

The second hose coupling 200 is defined by a coupling body 230 and a hose fitting 220, along with a through passage 210 extending between a first open end 212 and a second open end 214. The first open end 212 coincides with the end of the hose fitting 220 opposite that which is integral with the coupling body 230. The host fitting 220 may have the same structure as the hose fitting 120 of the first hose coupling 100, that is, a series of concentric ribs 133. However, this is by way of example only and not of limitation, and a different type of retention structure may be substituted without departing from the scope of the present disclosure.

The coupling body 230 is defined by a face 232 at the second open end 214 (see FIG. 4), the face 232 defining an annular recess 234 that corresponds to that portion of the first hose coupling 100 that is engageable to the second hose coupling 200, that is, the flange 130. A ferromagnetic ring 250 may be positioned within the annular recess 234, and have a thickness that is slightly less than that of the entire depth of the annular recess 234, such that the counterpart coupling body 102, including the flange 130, may be partially received within the recess 234.

The ferromagnetic ring 250 may be made of an unmagnetized ferromagnetic material that may include iron, cobalt, nickel, etc. The ferromagnetic ring 250 may, for example, be made of unmagnetized steel. Due to the large surface of the ferromagnetic ring 250 relative to that of the plurality of magnets 150, an unmagnetized material may be used without sacrificing magnetic force. Thus, by using an unmagnetized ferromagnetic ring 250 rather than a second magnet, costs may be reduced. Alternatively, the ferromagnetic ring 250 may itself be magnetized, such that both the magnets 150 and the ferromagnetic ring 150 are magnets. With the magnets 150 disposed within the circumferentially spaced recesses 134 and the ferromagnetic ring 250 disposed within the annular recess 234 (e.g. by adhesives or pressure fit), the magnets 150 may exert a magnetic force that attracts the ferromagnetic ring 250 when the first and second hose couplings 100, 200 draw near each other. The first and second hose couplings 100, 200 may thus be magnetically attached by placing the flange 130 of the first hose coupling 100 within the annular recess 234 of the second hose coupling 200 with the magnets 150 abutting the ferromagnetic ring 250 (see FIG. 6).

Referring back to the first hose coupling 100, the face 132 of the coupling body 102, and specifically in the region of the flange 130, may also define an annular recess 136 receptive to an O ring 160. The annular recess 136 may be sufficiently shallow to allow the O ring 160 to protrude therefrom. As shown in FIG. 6, the O ring 160 may thus compress against the ferromagnetic ring 250 to seal the first and second through passages 110, 210 when the first and second hose couplings 100, 200 are magnetically attached. In the example shown, the annular recess 136 for the O ring 160 surrounds the circumferentially spaced recesses 134. However, various other positions of the annular recess 136 may be possible provided that the O ring 160 can act as a seal to keep fluid within the through passages 110, 210. For example, the annular recess 136, and thus the O ring 160, may be positioned between the circumferentially spaced recesses 134 and the through passage 110. It is also contemplated that the annular recess 136 may pass through the circumferentially spaced recesses 134, such that the O ring 160 is disposed on top of the magnets 150 when the magnets 150 are in the circumferentially spaced recesses 134. However, in this case, the magnetic attraction between the magnets 150 and the ferromagnetic ring 250 may be less due to the intervening O ring 160.

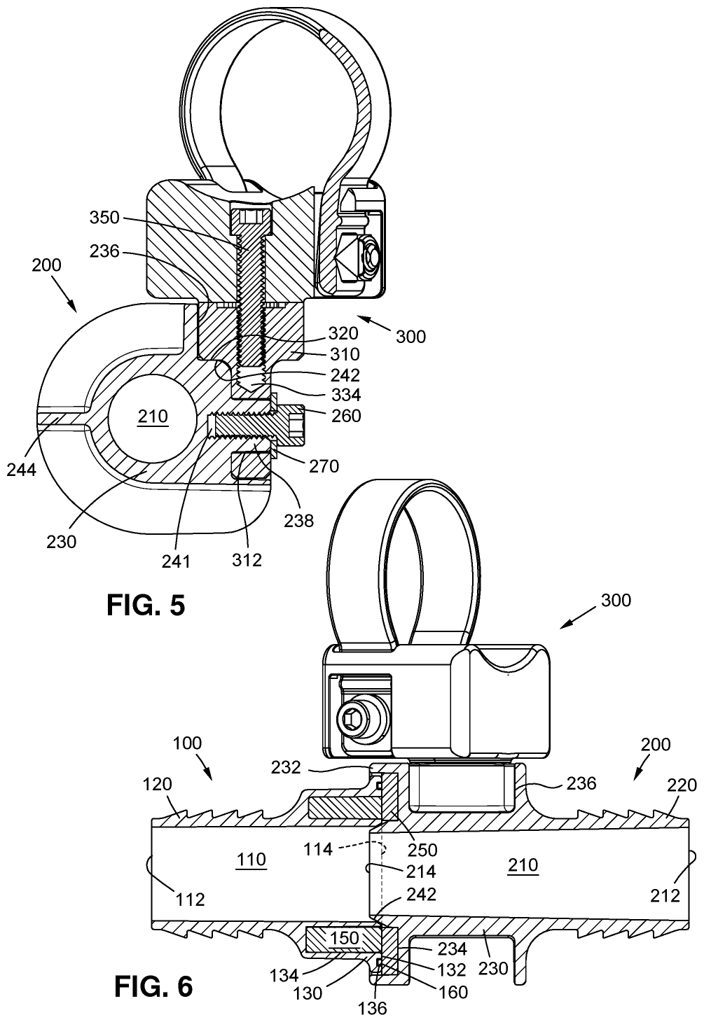

FIG. 5 is a cross-sectional view of the hose coupling system 10 taken along line 5-5 in FIG. 1. As best seen in FIGS. 2, 3, and 5, the coupling body 230 of the second hose coupling 200 may further define a receptacle 240 for the mount 300 and may have a boss 238 protruding outwardly from within the receptacle 240. The boss 238 may define a threaded interior 241 receptive to a bolt 260. To fix the mount 300 to the second hose coupling 200, a tongue 310 of the mount 300 may be placed in the receptacle 240 of the coupling body 230 with a through hole 312 of the tongue 310 receiving the boss 238. The tongue 310 may then be secured to the boss 238 with the bolt 260. A washer 270 may provide a contact surface for the head of the bolt 260, allowing the bolt 260 to have a head that is smaller than the through hole 312. The tongue 310 and receptacle 240 may have complementary shapes so that the tongue 310 may be prevented from rotating around the boss 238 by the walls of the receptacle 240. To further prevent rotation around the boss 238, as well as to prevent rotation about the axis of the through passage 210, the coupling body 230 of the second hose coupling 200 may further define a shoulder 242 within the receptacle 240. The mount 300 may have a complementary shoulder 320 (see FIG. 5) that abuts the shoulder 242 of the second hose coupling 200 while the tongue 310 is in the receptacle 240.

In general, the coupling body 230, and the face 232 thereof, defines the annular recess 234. The coupling body 230 also defines the receptacle 240 and associated boss 238. Whereas the face 232 of the body 230 may be oriented in a longitudinal direction of the through passage 210 so as to receive the flange 130 of the first hose coupling 100, the receptacle 240 and associated boss 230 may be oriented roughly normal to the through passage 210, e.g. on one side of the second hose coupling 200. As shown, the body 230 may extend about halfway down the length of the second hose coupling 200 in order to accommodate the receptacle 240. The body 230 may end where the hose fitting 220 begins and may, in some cases, provide a surface against which a hose may abut when it is connected to the hose fitting 220. For structural support and/or to provide a grip (e.g. when rotating the second hose coupling 200 as described below), the body 230 may have a longitudinal rib 244 opposite the receptacle 240 (see FIGS. 4 and 5).

FIG. 6 is a cross-sectional view of the hose coupling system 10 taken along line 6-6 in FIG. 1. As described above, the first and second hose couplings 100, 200 may be magnetically attached by placing the flange 130 of the first hose coupling 100 within the annular recess 234 of the second hose coupling 200 with the magnets 150 abutting the ferromagnetic ring 250. With the flange 130 of the first hose coupling 100 thus received by the annular recess 234 of the second hose coupling 200, a portion of the coupling body 230 of the second hose coupling 200 may fit within the second open end 114 of the first hose coupling 100 as shown in FIG. 6. In this way, fluid in the through passage 210 may flow directly into the through passage 110 without leakage. For example, as shown in FIG. 6, the through passage 210 defined by the second hose coupling 200 may taper from the first open end 212 to the second open end 214, with the resulting reduced diameter second open end 214 being smaller than the second open end 114 of the first hose coupling 100. Alternatively, the through passage 210 may have a constant diameter that is smaller than that of the through passage 110.

The portion of the coupling body 230 that fits within the second open end 114 of the first hose coupling 100 may define a sloped wall 242. When the first hose coupling 100 is attached to the second hose coupling 200, the sloped wall 242 may serve as a guide to aid in the location of the annular recess 234 with the flange 130 of the first hose coupling 100. Along the same lines, the internal edge of the flange 130 that defines the entry to the through passage 110 may be filleted or chamfered to provide a smooth contact surface with the sloped wall 242 of the second hose coupling 200. Since the sloped wall 242 allows the flange 130 to slide into the correct position during attachment, the system 10 may permit some degree of error in aligning the first and second hose couplings 100, 200. This may be especially useful when the person attaching the first and second hose couplings 200 is a driver who is focused on operating a vehicle. The foregoing fitted relationships are also contemplated to improve the sealing between the first hose coupling 100 and the second hose coupling 200.

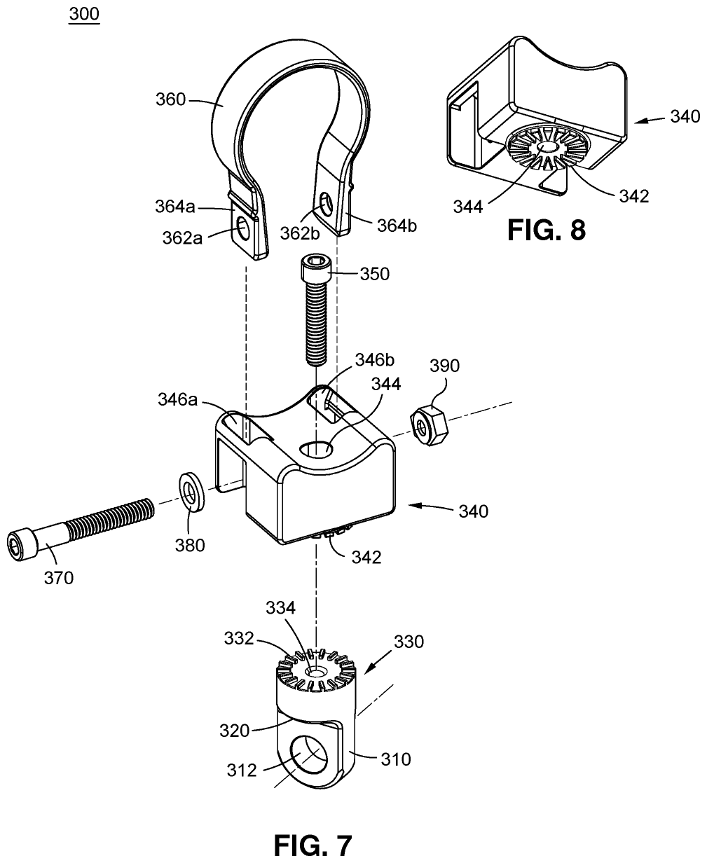

FIG. 7 is an exploded top perspective view of the mount 300. FIG. 8 is a partial bottom view of the mount 300. As described above, the mount 300 may include a tongue 310 that is received by a receptacle 236 formed in the body 230 of the second hose coupling 200. The tongue 310, as well as the through hole 312 and shoulder 320, may be part of a movable piece 330 of the mount 300 that rotates or otherwise moves relative to a fixed piece 340 of the mount 300. In the case of a rotatable mount 300 as shown in the example of FIGS. 7 and 8, the movable piece 330 may be attached to the fixed piece 340 via interlocking ribbed rings 332, 342 formed respectively on the movable piece 330 and fixed piece 340 and secured by a bolt 350 that extends through a through hole 344 of the fixed piece 340 and into a threaded interior 334 of the movable piece 330 (see FIG. 5). One or both of the interlocking ribbed rings 332, 342 may be compliant enough to allow the movable piece 330 and fixed piece 340 to be selectively rotated relative to each other when sufficient rotational force is applied, while at the same time the interlocking ribbed rings 332, 342 may generally resist unwanted rotation by virtue of the interlocking ribs. Thus, it is envisioned that a user may purposefully turn the movable piece 330 with relative ease, causing it to snap to a new position relative to the fixed piece 340 as the ribs of one or both of the interlocking ribbed rings 332, 334 bend slightly to allow a transition of one rib across another. Once the new position is established, the interlocking ribbed rings 332, 334 may generally prevent any unintended further rotation that may be caused, for example, by the force of gravity acting on the second hose coupling 200 and/or first hose coupling 100 attached to the movable piece 330. In this way, a desired orientation of the movable piece 330, and consequently of the second hose coupling 200, may be set relative to the vehicle attachment point 400. For example, the second hose coupling 200 may be oriented for the easiest possible access by the driver of the vehicle.

It should be noted that selective rotation of the movable piece 330 relative to the fixed piece 340 may also be achieved by other means. For example, the interlocking ribbed rings 332, 334 may be omitted and the bolt 350 may secure the fixed piece 340 tightly enough to the movable piece 330 to prevent rotation. The bolt 350 may then be unscrewed slightly by a user to allow free rotation of the bolt 350 and movable piece 330 relative to the fixed piece 340. As another example, the bolt 350 may only loosely secure the fixed piece 340 to the movable piece 330, and a set screw may be inserted through the fixed piece 340 to perpendicularly abut the bolt 350. This is understood to prevent rotation once a desired orientation is established. In addition, other kinds of relative positioning of the movable piece 330 and fixed piece 340 are envisioned besides rotation, such as translational positioning or hinging, with any and all appropriate structures contemplated by the present disclosure.

The attachment structure for securing the fixed piece 340 to the vehicle attachment point 400 may depend on the geometry of the vehicle attachment point 400. In the depicted example (see FIGS. 1 and 7, the mount 300 includes a ring clamp 360 having first and second ends 364a, 364b that are inserted into first and second openings 346a, 346b of the fixed piece 340. The ring clamp 360 is secured to the fixed piece 340 by a bolt 370 that extends through a washer 380, a first hole 362a in the first end 364a of the ring clamp 360, a second hole 362b in the second end 364b of the ring clamp 360, and a nut 390. The ring clamp 360 is only an example. Any type of roll bar clamp, tube clamp, etc. may be used to secure the fixed piece 340 to a tubular vehicle attachment point 400. In the case of other, non-tubular vehicle attachment points 400, including dashboards, headrests, consoles, air conditioning vents, etc., various other types of attachment structure may be used including clamps of any type, suction cups, adhesives, etc.

With the fixed piece 340 secured to the vehicle attachment point 400, the mount 300 may allow for selective rotation or other movement by the movable piece 330 as described above, providing for a wide range of possible positions and orientations of the attached second hose coupling 200 relative to the driver of the vehicle. In this way, the disclosed system 10, including a second hose coupling 200 with a receptacle 236 for such a mount 300, may allow a person to set up a static connection point for convenient magnetic attachment of the first hose coupling 100 as needed. A driver or other vehicle operator may thus have easy access to a supply of hydration, air, or other fluid without impairing the safe operation of the vehicle.

Throughout the above description, it is assumed for the sake of simplicity that a driver or other vehicle operator is the recipient of fluid, such that the fluid flows from a fluid source, through a hose connected to the second hose coupling 200, through a hose connected to the first hose coupling 100, and to the driver's helmet or other outlet. However, the present disclosure is not intended to be so limited. For example, the driver or other vehicle operator may instead by expelling fluid through the system 10, such as the driver's own exhaled air or a vehicle waste product. Thus, it is contemplated that the fluid may flow in the opposite direction, i.e., from a fluid source near the driver, through a hose connected to the first hose coupling 100, through a hose connected to the second hose coupling 200, and to an exhaust or other outlet. The system 10 may be used in either flow direction and in some cases may be used interchangeably in both flow directions. In the case of a flow of fluid from the first hose coupling 100 into the second hose coupling 200, it is also contemplated that the first hose coupling 100 may fit within the second open end 214 of the second hose coupling 200 rather than the other way around (see FIG. 6) in order to prevent leakage. The above-described structures of the first and second hose couplings 100, 200 may thus be reversed in part, for example, by providing the sloped wall 242 and/or taper features to the first hose coupling 100 rather than the second hose coupling 200.

More generally, it is contemplated that the hose coupling system 10 may be used in a variety of industries, not only for vehicle operators. For example, in the medical field, a patient may be provided with oxygen or otherwise connected to any of various medical hoses for receiving or expelling fluids to and from the patient's body. The hose coupling system 10 may provide a convenient mechanism for connecting to such medical hoses. In such case, the attachment point 400 to which the fixed piece 340 of the mount 300 is secured may be, for example, a pole mount, a hospital bed, or another piece of equipment available in a hospital or other care setting.

In the above description, it is described by way of example that the first hose coupling 100 is provided with a plurality of magnets 150 and the second hose coupling 200 is provided with a ferromagnetic ring 250, which may or may not be magnetized. However, the disclosure is not intended to be limited to this arrangement. For example, the first hose coupling 100 may instead be provided with the ferromagnetic ring 250, and the second hose coupling 200 may have the plurality of magnets 150.

The various parts of the system 10 including the first hose coupling 100, second hose coupling 200, and mount 300 may be made of plastic or elastomer, e.g., a thermoplastic polymer such as acrylonitrile butadiene styrene (ABS) or a polyurethane plastic such as thermoplastic polyurethane (TPU).

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, b the scope of the claims is not to be limited by the illustrated embodiments.

What is claimed is:

1. A hose coupling system comprising:
a first hose coupling defining a through passage with first and second open ends, the first hose coupling having a hose fitting at the first open end and a flange at the second open end, the flange having a face defining a plurality of circumferentially spaced recesses;
a plurality of magnets, each disposed within a respective one of the plurality of circumferentially spaced recesses;
a second hose coupling defining a through passage with first and second open ends, the second hose coupling having a hose fitting at the first open end and a body with a face at the second open end, the face defining an annular recess receptive to the flange of the first hose coupling, the body further defining a receptacle for a mount and having a boss protruding outwardly from within the receptacle; and
a ferromagnetic ring disposed within the annular recess.

2. The hose coupling system of claim 1, further comprising an O ring, wherein the face of the flange of the first hose coupling further defines an annular recess receptive to the O ring.

3. The hose coupling system of claim 1, wherein the boss defines a threaded interior receptive to a bolt.

4. The hose coupling system of claim 1, further comprising a mount having a tongue that fits within the receptacle, the tongue defining a through hole receptive to the boss.

5. The hose coupling system of claim 1, wherein the body of the second hose coupling further defines a shoulder within the receptacle.

6. The hose coupling system of claim 5, further comprising a mount having a tongue that fits within the receptacle and a shoulder that abuts the shoulder of the second hose coupling, the tongue defining a through hole receptive to the boss.

7. The hose coupling system of claim 1, wherein a portion of the body of the second hose coupling fits within the second open end of the first hose coupling with the flange of the first hose coupling received by the annular recess.

8. The hose coupling system of claim 7, wherein the portion of the body of the second hose coupling that fits within the second open end of the first hose coupling defines a sloped wall of the annular recess.

9. The hose coupling system of claim 1, wherein the through passage defined by the second hose coupling tapers from the first open end to the second open end.

10. The hose coupling system of claim 1, wherein the body of the second hose coupling has a longitudinal rib opposite the receptacle.

11. The hose coupling system of claim 1, wherein the ferromagnetic ring is made of unmagnetized steel.

12. A hose coupling system comprising:
a hose coupling defining a through passage with first and second open ends, the hose coupling having a hose fitting at the first open end and a body with a face at the second open end, the face defining an annular recess receptive to a flange of another hose coupling, the body further defining a receptacle for a mount and having a boss protruding outwardly from within the receptacle; and
a ferromagnetic ring disposed within the annular recess.

13. The hose coupling system of claim 12, wherein the boss defines a threaded interior receptive to a bolt.

14. The hose coupling system of claim 12, further comprising a mount having a tongue that fits within the receptacle, the tongue defining a through hole receptive to the boss.

15. The hose coupling system of claim 12, wherein the body of the hose coupling further defines a shoulder within the receptacle.

16. The hose coupling system of claim 15, further comprising a mount having a tongue that fits within the receptacle and a shoulder that abuts the shoulder of the hose coupling, the tongue defining a through hole receptive to the boss.

17. The hose coupling system of claim 12, wherein the body of the hose coupling defines a sloped wall of the annular recess.

18. The hose coupling system of claim 12, wherein the through passage defined by the hose coupling tapers from the first open end to the second open end.

19. The hose coupling system of claim 12, wherein the body of the hose coupling has a longitudinal rib opposite the receptacle.

20. The hose coupling system of claim 1, wherein the ferromagnetic ring is made of unmagnetized steel.
